(19) United States
(12) Patent Application Publication
(10) Pub. No.: US 2009/0097591 A1
(43) Pub. Date: Apr. 16, 2009

(54) APPARATUS AND METHOD FOR ENVELOPE TRACKING POWER AMPLIFICATION IN WIRELESS COMMUNICATION SYSTEM

(75) Inventor: Byung-Wook KIM, Suwon-si (KR)

Correspondence Address: Jefferson IP Law, LLP, 1730 M Street, NW, Suite 807, Washington, DC, 20036, US

(73) Assignee: Samsung Electronics Co., Ltd., Suwon-si (KR)

(21) Appl. No.: 12/249,079

(22) Filed: Oct. 10, 2008

(30) Foreign Application Priority Data
Oct. 10, 2007 (KR) 2007-0101826

(51) Int. Cl. H04L 25/49

(52) U.S. Cl. 375/297

(57) ABSTRACT

An apparatus and a method for Envelope Tracking (ET) power amplification in a wireless communication system are provided. The apparatus includes a baseband signal controller for outputting an envelope signal in an envelope signal path and outputting a constant signal in a baseband signal path when measuring a time delay of the envelope signal path, and for outputting a constant signal in the envelope signal path and outputting a baseband signal in the baseband signal path when measuring a time delay of the baseband signal path, a time delay difference measurer for measuring a time delay of each path by calculating a correlation coefficient between the envelope signal path and the baseband signal path and a signal time controller for setting a time delay in a corresponding path using the time delay difference of each path and aligning times.

### PRIORITY

This application claims the benefit under 35 U.S.C. §119(a) of a Korean patent application filed in the Korean Intellectual Property Office on Oct. 10, 2007 and assigned Serial No. 2007-101826, the entire disclosure of which is hereby incorporated by reference.

### BACKGROUND OF THE INVENTION

1. Field of the Invention

The present invention relates generally to an apparatus and a method for amplifying power in a wireless communication. More particularly, the present invention relates to an apparatus and a method for power amplification by Envelope Tracking (ET) to compensate for a delay difference by independently measuring a delay per path.

2. Description of the Related Art

In response to the wide use of wireless communications, it is necessary for a mobile terminal and a base station system to amplify a digital-modulated signal up to an intended transmit power using a Radio Frequency (RF) power amplifier and to transmit the amplified signal. In doing so, to avoid the distorted signal transmission, the power amplifier requires high-linearity and high-efficiency characteristics.

Based on the need for high-efficiency by the power amplifier, research is being conducted on an Envelope Tracking (ET) based transmitter. The ET based transmitter is a system which controls the power supply of the power amplifier to conform to the envelope of the transmit signal. When the magnitude of the transmit signal increases, the power supply of the power amplifier is increased. Similarly, when the magnitude of the transmit signal decreases, the power supply is reduced. Such a method can increase the power efficiency as compared to the fixed power designed in consideration of the maximum magnitude of the transmit signal. However, to avoid distortion of the output signal of the ET based transmitter, an exact time alignment is required between the output signal of the envelope signal amplifier, which controls the magnitude of the supply power of the power amplifier, and the baseband signal fed to the power amplifier. That is, it is necessary to adjust the timing between the output signal of the envelope signal amplifier and the baseband signal fed to the power amplifier. If the time alignment is not performed accurately, the spectrum characteristic of the power amplifier output signal is distorted.

To prevent the degradation of the power amplifier output signal, it is necessary to accurately measure a time taken for the baseband signal to be supplied to the power amplifier in an envelope signal path and a time taken for the baseband signal to pass through the path to the power amplifier. Based on the measured times, the time difference per path should be adjusted.

Various conventional methods have been suggested to measure the time delay difference and achieve more accurate time alignment. For example, a method for measuring a distortion signal to measure a delay difference per path (US patent application publication No. 2006/0246856 A1, titled “Transmitter apparatus, communication apparatus, and Mobile radio apparatus”), a method for measuring a phase difference of a test signal (Korean patent application publication No. 10-2005-0074917, titled “Timing measurement method for wireless communication apparatus”), and a method for measuring a time delay using a correlation coefficient measurement (US patent application publication No. 2006/0234652 A1, titled “Transmission apparatus”), each of which is hereby incorporated by reference, have been disclosed.

However, the time alignment method using either the distortion signal caused by the delay difference or the phase measurement of the test signal is subject to low accuracy because it is difficult to define a relational expression to derive the quantitative delay difference from the measurement. Furthermore, such a method may require additional functions.

A transmitter that includes an Envelope Elimination and Restoration (EER) system using a polar modulation utilizes a correlation coefficient measurement using the envelope signal and the phase modulation signal used to measure the time delay. Since the envelope signal and the phase modulation signal of the transmitter using the polar modulation are independent of each other, it is possible to individually separate and measure mutual delay characteristics by measuring the correlation coefficient of each signal with respect to the RF signal output from the power amplifier. In contrast, in the ET transmitter, the envelope signal and the baseband signal supplied to the power amplifier are not independent of each other. Accordingly, the correlation coefficient measurement results of the envelope signal and the baseband signal with respect to the RF signal amplified and output from the power amplifier are not independent of each other and interfere with each other. As a result, it is difficult to measure the delay difference using the correlation coefficient measurement on the envelope signal and the baseband signal.

### SUMMARY OF THE INVENTION

An aspect of the present invention is to address at least the above mentioned problems and/or disadvantages and to provide at least the advantages described below. Accordingly, an aspect of the present invention is to provide an apparatus and a method for Envelope Tracking (ET) power amplification to compensate for a time delay by independently measuring a time delay difference per path in a wireless communication system.

In accordance with an aspect of the present invention, an apparatus for ET power amplification in a wireless communication system is provided. The apparatus includes a baseband signal controller for outputting an envelope signal in an envelope signal path and outputting a constant signal in a baseband signal path when measuring a time delay of the envelope signal path, and for outputting a constant signal in the envelope signal path and outputting a baseband signal in the baseband signal path when measuring a time delay of the baseband signal path, a time delay difference measurer for measuring a time delay of each path by calculating a correlation coefficient of the envelope signal path and of the baseband signal path and a signal time controller for setting a time delay in a corresponding path using the time delay difference of each path.

In accordance with another aspect of the present invention, a method for ET power amplification in a wireless communication system is provided. The method includes outputting an envelope signal in an envelope signal path and outputting a constant signal in a baseband signal path when measuring a time delay of the envelope signal path and outputting a constant in the envelope signal path and outputting a baseband signal in the baseband signal path when measuring a time delay of the baseband signal path, measuring a time delay of each path by calculating a correlation coefficient of the envelope signal path and of the baseband signal path and setting a time delay in a corresponding path using the time delay difference of each path and aligning times.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIGS. 1A and 1B are block diagrams of a power amplification transmitter based on ET according to an exemplary embodiment of the present invention;

FIG. 2 is a graph illustrating performance based on an adjacent channel leakage ratio and a constellation error of an RF signal when a time delay difference is generated between an envelope signal path and a baseband signal path;

FIGS. 3A and 3B are graphs illustrating correlation coefficients of the time delay difference between an envelope signal path and a baseband signal path and comparing results according to a conventional art and an exemplary embodiment of the present invention, respectively; and

FIG. 4 is a flowchart of a power amplification method based on ET according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and a method for an Envelope Tracking (ET) based power amplification to compensate for a time delay by independently measuring a time delay difference per path in a wireless communication system.

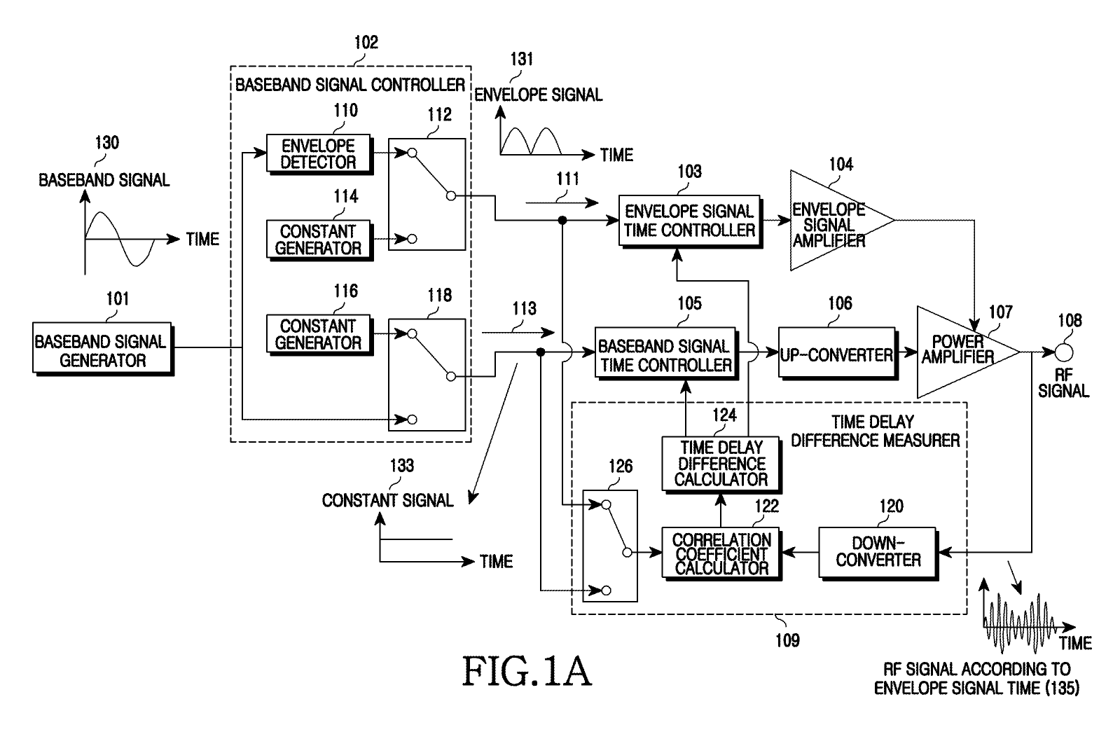

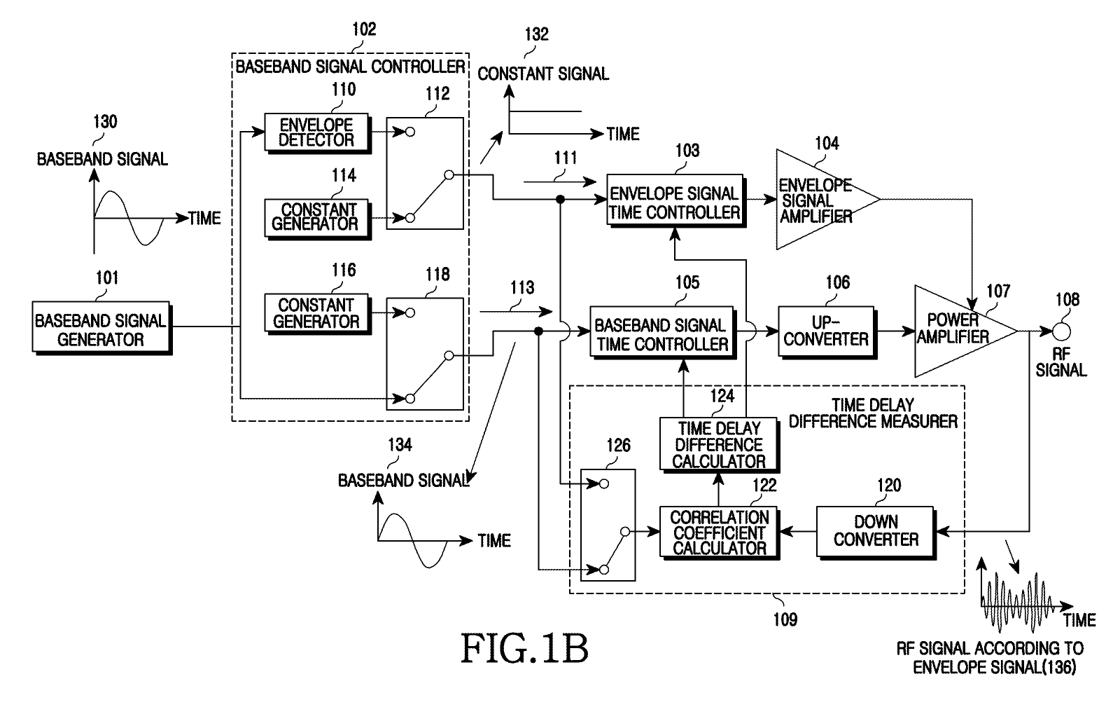

FIGS. 1A and 1B are block diagrams of a power amplification transmitter based on ET according to an exemplary embodiment of the present invention. As will be explained in more detail below, while the same power amplification transmitter components are illustrated in both FIGS. 1A and 1B, FIG. 1A illustrates a configuration of the components that is different from that of FIG. 1B.

Referring to FIGS. 1A and 1B, the power amplification transmitter includes a baseband signal generator 101 that generates a baseband signal 130, a baseband signal controller 102, including an envelope detector 110 and constant signal generators 114 and 116, for controlling to generate a desired signal in each path, an envelope signal time controller 103 for controlling a time delay of an envelope signal, an envelope signal amplifier 104 for supplying a power voltage to a power amplifier according to the magnitude of the envelope signal, a baseband signal time controller 105 for controlling a time delay of a baseband signal, an up-converter 106 for up-converting a baseband signal to a Radio Frequency (RF) signal, a power amplifier 107 for amplify the up-converted RF signal and outputting an RF signal 108, and a time delay difference measurer 109 for measuring a time delay difference using the RF signal 108 output from the power amplifier 107 and the signal in each path and for controlling the time delay controllers.

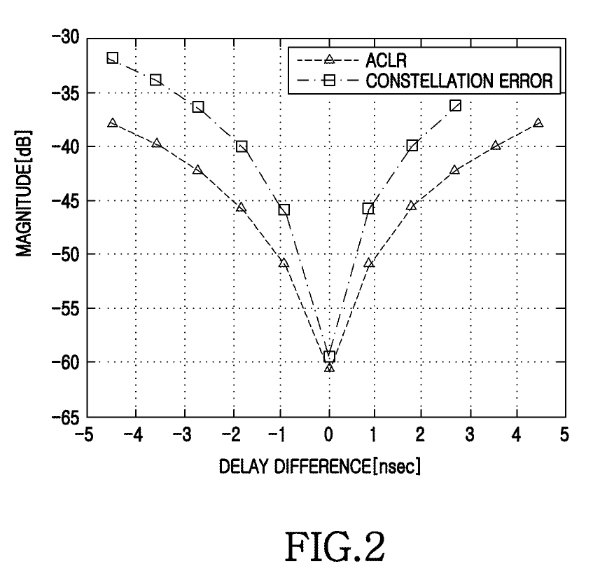

When the time alignment between the time delay of the envelope signal path 111 and the baseband signal path 113 of the ET based transmitter is not accurately performed, the RF signal 108 output from the power amplifier 107 deteriorates. FIG. 2 depicts a performance variation based on an Adjacent Channel Leakage Ratio (ACLR) and a constellation error of the RF signal 108 when a time delay difference is generated between the envelope signal path 111 and the baseband signal path 113 in the ET based transmitter. As illustrated in FIG. 2, when the time delay increases, the signal performance worsens. Furthermore, because the time delay difference is measured in nanoseconds, very accurate measurement and control are required. Since the envelope signal and the baseband signal are not independent of each other, the time delay difference acquired by measuring correlation coefficients of the envelope signal and the baseband signal with respect to the RF signal 108 output from the power amplifier 107 is subject to interference and inaccurate result. To prevent this, exemplary embodiments of the present invention provide a process and a structure for measuring the time delays of the paths of the respective signals.

As illustrated in FIG. 1A, to measure the time delay of the envelope signal path 111, the baseband signal controller 102 controls its switches 112 and 118 to output the envelope signal 131, as output by the envelope detector 110, in the envelope signal path 111 and to output a constant value 133, output by the constant signal generator 116 and having a waveform that does not change over time, in the baseband signal path 113. When those signals are output through the power amplifier 107, a signal 135, in which the envelope signal 131 is up-converted on the RF carrier frequency, is produced. Similarly, as illustrated in FIG. 1B, to measure the time delay of the baseband signal path 113, the baseband signal controller 102 controls its switches 112 and 118 to output a constant value 132, output by the constant signal generator 114 and having a waveform that does not change over time, in the envelope signal path 111 and to output the baseband signal 134 in the baseband signal path 113. As a result, a signal 136, in which the baseband signal 134 is up-converted on the RF carrier frequency, is produced. As such, after controlling the signal of each path, the time delay difference measurer 109 determines the time delay of each path and determines a difference between the time delays of the paths.

After the difference in time delays is determined, the signal time controllers 103 and 105 adjust the time delay in each signal path. More specifically, the time delay is adjusted using the clock period in the signal path having less of a time delay according to the time delay difference. Also, the time delay of the signal path having the greater time delay is adjusted to the remaining signal time difference. For example, when the delay time τₑₙᵥ of the envelope signal is longer than the delay time τ_{bb} of the baseband signal (N>0), the signal time controllers 103 and 105 define the path of the baseband signal as a time delay represented as an integer number of times of the N-time clock period, and define the path of the envelope signal as a time delay τ_{red} which is the remaining time delay difference. When the delay time τₑₙᵥ of the envelope signal is shorter than the delay time τ_{bb} of the baseband signal (N<0), the path of the envelope signal is defined as a time delay represented as an integer number of times of the N-time clock period and the path of the baseband signal is defined as a time delay τ_{red} which is the remaining time delay difference.

The time delay difference measurer 109 includes a down-converter 120, a correlation coefficient calculator 122, a time delay difference calculator 124, and a switch 126.

The down-converter 120 down-converts the RF signal, output from the power amplifier 107, to a baseband signal. The correlation coefficient calculator 122 determines a correlation coefficient between the envelope signal 131 and the constant signal 132 of the envelope signal path 111, output from the switch 126, and the down-converted signal, output from the down-converter 120, and acquires the delay time τₑₙᵥ of the envelope signal path 111 by locating the peak of the correlation coefficient value. The correlation coefficient calculator 122 also determines a correlation coefficient between the baseband signal 133 and the constant signal 134 of the baseband signal path 113, output via the switch 126, and the down-converted signal, output from the down-converter 120, and obtains the delay time τ_{bb} of the baseband signal path 113 by locating the peak of the correlation coefficient value.

Herein, when measuring the time delay of the envelope signal path 111, the switch 126 switches to interconnect the envelope signal path 111 and the correlation coefficient calculator 122. When measuring the time delay of the baseband signal path 113, the switch 126 switches to interconnect the baseband signal path 113 and the correlation coefficient calculator 122.

The time delay difference calculator 124 determines a time delay difference τ_{diff}=τₑₙᵥ−τ_{bb} from the delay time τₑₙᵥ of the envelope signal path 111 and the delay time τ_{bb} of the baseband signal path 113 measured at the correlation coefficient calculator 122, and provides the acquired time delay difference to the envelope signal time controller 103 and the baseband signal time controller 105. In doing so, the time delay difference calculator 124 represents the delay time difference τ_{diff} using a quotient N and a remainder τ_{red} with respect to a digital clock period Ts.

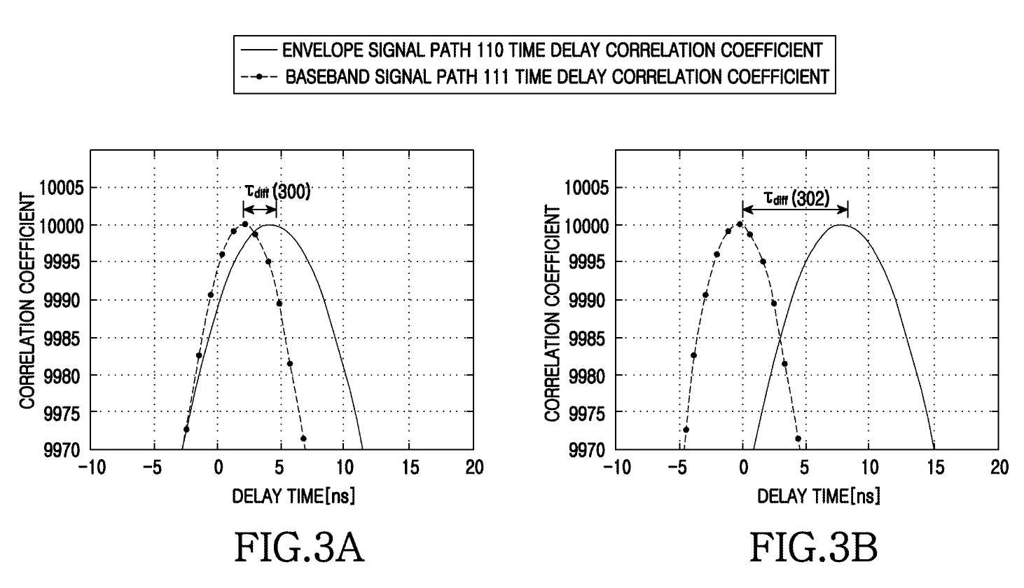

FIGS. 3A and 3B are graphs illustrating correlation coefficients when the time delay difference between the envelope signal path 111 and the baseband signal path 113 is about 8 ns. Herein, the reference time delay of the baseband path is set to zero and the time delay of the envelope signal path is set to approximately 8 ns.

FIG. 3A depicts the inaccurate time delay difference 300 due to interference between the signals of the paths in the conventional method. Particularly, the time delay of the baseband path signal is not zero and suffers the time delay and the time delay of the envelope signal is not correctly measured as well. FIG. 3B depicts the correlation coefficients of the signals of the paths measured according to an exemplary embodiment of the present invention and represents the accurate time delay difference 302 of the measured paths.

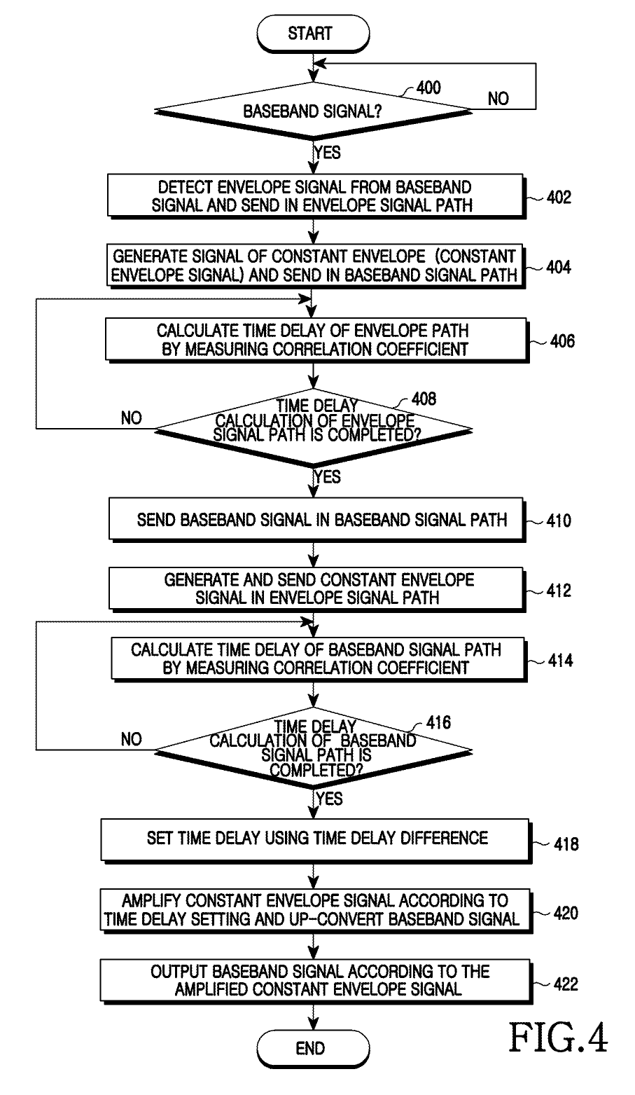

FIG. 4 is a flowchart of a power amplification method based on ET according to an exemplary embodiment of the present invention.

Referring to FIG. 4, in step 400, the power amplification apparatus determines whether a baseband signal is received. If it is determined that the baseband signal is received, the power amplification apparatus detects an envelope signal from the baseband signal and sends the envelope signal in the envelope signal path 111 in step 402.

In step 404, the power amplification apparatus generates a signal having a constant envelope magnitude (hereinafter, referred to as a constant signal) and sends the constant signal in the baseband signal path 113.

In step 406, the power amplification apparatus calculates a correlation coefficient between the down-converted signal and the input envelope signal and obtains a delay time τₑₙᵥ of the envelope signal path by locating the peak of the correlation coefficient value.

When it is determined that the calculation of the delay time of the envelope signal path is completed in step 408, the power amplification apparatus sends the baseband signal in the baseband signal path in step 410.

In step 412, the power amplification apparatus generates a signal having a constant envelope magnitude (hereinafter, referred to as a constant signal) and sends the constant signal in the envelope signal path.

In step 414, the power amplification apparatus calculates a correlation coefficient between the down-converted signal and the input baseband signal and obtains a delay time τ_{bb} of the baseband signal path by locating the peak of the correlation coefficient value.

When it is determined that the calculation of the delay time of the baseband signal path is completed in step 416, the power amplification apparatus calculates a time delay difference τ_{diff}=τₑₙᵥ−τ_{bb} from the delay time τₑₙᵥ of the envelope signal path 111 and the delay time τ_{bb} of the baseband signal path 113 and sets the time delay to align the times in step 418. That is, the power amplification apparatus controls to equal the input time of the baseband signal to the power amplifier and the input time of the envelope signal to the power amplifier.

In various implementations, the processing order may be altered. For example, after the time delay of the baseband signal path is measured in steps 410 to 414, the time delay of the envelope signal path can be measured in steps 402 to 406.

In step 420, the power amplification apparatus amplifies the signal of the envelope signal path according to the set time delay and up-converts the signal of the baseband signal.

In step 422, the power amplification apparatus amplifies and outputs the signal of the baseband signal path according to the envelope signal.

Next, the power amplification apparatus finishes the ET based power amplification.

As set forth above, since the time delay difference is calculated by distinguishing the envelope signal path and the baseband signal path in the wireless communication system, the time delay differences of the paths can be independently measured with accuracy. Based on the time delay difference, the accuracy of the time alignment can be raised and the distortion of the spectrum performance of the final RF signal can be prevented.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for Envelope Tracking (ET) power amplification in a wireless communication system, the apparatus comprising:
a baseband signal controller for outputting an envelope signal in an envelope signal path and outputting a constant signal in a baseband signal path when measuring a time delay of the envelope signal path, and for outputting a constant signal in the envelope signal path and outputting a baseband signal in the baseband signal path when measuring a time delay of the baseband signal path;
a time delay difference measurer for measuring a time delay of each path by calculating a correlation coefficient of the envelope signal path and of the baseband signal path; and
a signal time controller for setting a time delay in a corresponding path using the time delay difference of each path.

2. The apparatus of claim 1, wherein the baseband signal controller comprises:
an envelope detector for detecting the envelope signal from the baseband signal when measuring the time delay of the envelope signal path; and
a first switch for switching the detected envelope signal to the envelope signal path.

3. The apparatus of claim 1, wherein the baseband signal controller comprises:
a constant signal generator for generating the constant signal when measuring the time delay of the envelope signal path; and
a second switch for switching the constant signal to the baseband signal path.

4. The apparatus of claim 1, wherein the baseband signal controller comprises:
a constant signal generator for generating the constant signal when measuring the time delay of the baseband signal path; and
a first switch for switching the constant signal to the envelope signal path.

5. The apparatus of claim 1, wherein the baseband signal controller comprises:
a second switch for switching the baseband signal to the baseband signal path when measuring the time delay of the baseband signal path.

6. The apparatus of claim 1, wherein the time delay difference measurer comprises:
a third switch for switching to a signal from the envelope signal path when measuring the time delay of the envelope signal path, and for switching to a signal from the baseband signal path when measuring the time delay of the baseband signal path.

7. The apparatus of claim 1, wherein the time delay difference measurer comprises:
a down-converter for down-converting a Radio Frequency (RF) signal into a baseband signal;
a correlation coefficient calculator for calculating a correlation coefficient between the down-converted signal and one of the envelope signal and the baseband signal; and
a time delay difference calculator for receiving an envelope signal time delay τₑₙᵥ and a baseband time delay τ_{bb} from the correlation coefficient calculator and calculating a delay time difference τ_{diff}=τₑₙᵥ−τ_{bb}.

8. The apparatus of claim 7, wherein the time delay difference calculator represents the delay time difference τ_{diff} using a quotient N and a remainder τ_{red} with respect to a digital clock period Tₛ.

9. The apparatus of claim 1, wherein the signal time controller sets a time delay to a clock period unit in a signal path having a smaller time delay and sets a time delay as a remaining time delay difference in a signal path having a greater time delay according to the time delay difference.

10. The apparatus of claim 1, wherein, when the delay time τₑₙᵥ of the envelope signal is longer than the delay time τ_{bb} of the baseband signal (N>0), the time delay controller sets the path of the baseband signal to a time delay represented as an integer number of times of an N-time clock period and sets the path of the envelope signal to a time delay τ_{red} which is the remaining time delay difference, and when the delay time τₑₙᵥ of the envelope signal is shorter than the delay time τ_{bb} of the baseband signal (N<0), the time delay controller sets the path of the envelope signal to a time delay represented as an integer number of times of the N-time clock period and sets the path of the baseband signal to a time delay τ_{red} which is the remaining time delay difference.

11. The apparatus of claim 1, further comprising:
an amplifier for amplifying the baseband signal according to the envelope signal.

12. The apparatus of claim 11, wherein the amplifier comprises:
an envelope signal amplifier for amplifying the envelope signal and supplying power to a power amplifier; and
an up-converter for up-converting the baseband signal into a RF band,
wherein the power amplifier amplifies the up-converted phase signal according to a magnitude of the envelope signal.

13. A method for Envelope Tracking (ET) power amplification in a wireless communication system, the method comprising:
outputting an envelope signal in an envelope signal path and outputting a constant signal in a baseband signal path when measuring a time delay of the envelope signal path, and outputting a constant signal in the envelope signal path and outputting a baseband signal in the baseband signal path when measuring a time delay of the baseband signal path;
measuring a time delay of each path by calculating a correlation coefficient between the envelope signal path and the baseband signal path; and
setting a time delay in a corresponding path using the time delay difference of each path and aligning times.

14. The method of claim 13, wherein the outputting of the envelope signal in the envelope signal path comprises:
detecting the envelope signal from the baseband signal when measuring the time delay of the envelope signal path; and
switching the detected envelope signal to the envelope signal path.

15. The method of claim 13, wherein the outputting of the constant signal in the baseband signal path comprises:
generating a constant signal when measuring the time delay of the envelope signal path; and
switching the constant signal to the baseband signal path.

16. The method of claim 13, wherein the outputting of the constant signal in the envelope signal path comprises:
generating a constant signal when measuring the time delay of the baseband signal path; and
switching the constant signal to the envelope signal path.

17. The method of claim 13, wherein the outputting of the baseband signal in the baseband signal path comprises:
switching the baseband signal to the baseband signal path when measuring the time delay of the baseband signal path.

18. The method of claim 13, wherein the measuring of the time delay comprises:
switching to a signal from the envelope signal path when measuring the time delay of the envelope signal path, and switching to a signal from the baseband signal path when measuring the time delay of the baseband signal path.

19. The method of claim 13, wherein the measuring of the time delay comprises:
down-converting a Radio Frequency (RF) signal into a baseband signal;
calculating a correlation coefficient between the down-converted signal and one of the envelope signal and the baseband signal; and
receiving an envelope signal time delay τₑₙᵥ and a baseband time delay τ_{bb} from the correlation coefficient and calculating a delay time difference τ_{diff}=τₑₙᵥ−τ_{bb}.

20. The method of claim 19, wherein the delay time difference Υ_{diff} is represented using a quotient N and a remainder τ_{red} with respect to a digital clock period Tₛ.

21. The method of claim 13, wherein the setting of the time delay comprises setting a time delay to a clock period unit in a signal path having a smaller time delay and sets a time delay as a remaining time delay difference in a signal path having a greater time delay according to the time delay difference.

22. The method of claim 13, wherein, when the delay time τₑₙᵥ of the envelope signal is longer than the delay time τ_{bb} of the baseband signal (N>0), the third operation sets the path of the baseband signal to a time delay represented as an integer number of times of an N-time clock period and sets the path of the envelope signal to a time delay τ_{red} which is the remaining time delay difference, and when the delay time τₑₙᵥ of the envelope signal is shorter than the delay time τ_{bb} of the baseband signal (N<0), the third operation sets the path of the envelope signal to a time delay represented as an integer number of times of the N-time clock period and sets the path of the baseband signal to a time delay τ_{red} which is the remaining time delay difference.

23. The method of claim 13, further comprising:
amplifying the baseband signal according to the envelope signal.

24. The method of claim 23, wherein the amplifying of the baseband signal comprises:
amplifying the envelope signal and supplying power to a power amplifier;
up-converting the baseband signal into an RF band; and
amplifying the up-converted phase signal according to a magnitude of the envelope signal.
